(19) United States
(12) Patent Application Publication
(10) Pub. No.: US 2020/0119362 A1
(43) Pub. Date: Apr. 16, 2020

(54) POSITIVE ELECTRODE FOR SECONDARY BATTERIES, AND SECONDARY BATTERY

(71) Applicant: Panasonic Intellectual Property Management Co., Ltd., Osaka (JP)

(72) Inventors: Daisuke Furusawa, Osaka (JP); Hideharu Takezawa, Nara (JP); Tomoki Shiozaki, Osaka (JP)

(73) Assignee: Panasonic Intellectual Property Management Co., Ltd., Osaka (JP)

(21) Appl. No.: 16/713,421

(22) Filed: Dec. 13, 2019

Related U.S. Application Data
(63) Continuation of application No. PCT/JP2018/017141, filed on Apr. 27, 2018.

(30) Foreign Application Priority Data
Jun. 20, 2017 (JP) 2017-120722

(51) Int. Cl. H01M 4/66; H01M 4/505; H01M 4/525

(52) U.S. Cl. CPC H01M 4/668; H01M 2004/028; H01M 4/525; H01M 4/505

(57) ABSTRACT

This positive electrode is provided with: a positive electrode current collector, a protective layer which is formed on the positive electrode current collector and contains a silicone resin and a conductive material; and a positive electrode mixture layer which is formed on the protective layer and contains a positive electrode active material that is configured from a lithium-containing transition metal oxide.

### TECHNICAL FIELD

The present disclosure relates to a positive electrode for a secondary battery and to a secondary battery.

### BACKGROUND ART

A non-aqueous electrolyte secondary battery, which achieves charge and discharge by movement of lithium ions between positive and negative electrodes, has a high energy density and a large capacity, and is thus used widely as a power source for driving mobile digital assistants such as a cellular phone, notebook computer, smartphone, or as a power source for engines of electric tools, electric vehicles (EV), hybrid electric vehicles (HEV, PHEV), and the like.

Patent Literature 1 discloses an electrode plate for a non-aqueous electrolyte secondary battery formed by laminating a primer layer and an electrode active material layer in this order on a current collector, wherein the electrode active material layer contains a binder material composed of electrode active material particles and a metal oxide, and the primer layer contains silicon element and oxide element in a particular ratio. Patent Literature 1 describes that by the presence of the specific primer layer between the current collector and the electrode active material layer, it is possible to prevent the electrode active material layer from peeling off and falling from the current collector and make the electrode plate usable stably for a long term.

### CITATION LIST

### Patent Literature

PATENT LITERATURE 1: Japanese Unexamined Patent Application Publication No. 2012-94409

### SUMMARY

A positive electrode for a secondary battery is desired which may suppress increase in temperature caused when abnormalities occur such as internal short-circuit and enhance safety of the secondary battery while maintaining good current collectability.

The positive electrode for a secondary battery as one aspect of the present disclosure comprises a positive electrode current collector, a protective layer formed on the positive electrode current collector and including a silicone resin and a conductive agent, and a positive electrode mixture layer formed on the protective layer and including a positive electrode active material composed of a lithium-containing transition metal oxide.

According to the positive electrode for a secondary battery as one aspect of the present disclosure, it is possible to provide a secondary battery which suppresses increase in temperature caused when abnormalities occur such as internal short-circuit and which has enhanced safety while maintaining good current collectability.

### BRIEF DESCRIPTION OF DRAWING

FIG. 1 is a longitudinal sectional view showing an overview of a secondary battery as one example of embodiments.

### DESCRIPTION OF EMBODIMENTS

Patent Literature 1 discloses a technique of providing a primer layer containing silicon element and oxygen element in a particular ratio between the current collector and the electrode active material layer, more specifically, a technique of providing a primer layer by heating a coating film of a coating liquid obtained by dissolving and hydrolyzing a so-called silane coupling agent. However, since a resin obtained by hydrolysis of a silane coupling agent usually has electrical insulation property, there are worries about decrease of current collectability when the electrode plate is provided with the primer layer.

The positive electrode for a secondary battery (hereinafter, also referred to as “positive electrode”) as one aspect of the present disclosure comprises a positive electrode current collector, a protective layer formed on the positive electrode current collector and including a silicone resin and a conductive agent, and a positive electrode mixture layer formed on the protective layer and including a positive electrode active material composed of a lithium-containing transition metal oxide.

The present inventors found that when the above-mentioned protective layer is provided between the positive electrode current collector and the positive electrode mixture layer, it is possible to suppress increase in temperature caused when abnormalities occur such as internal short-circuit between the positive electrode current collector and the positive electrode mixture layer and enhance safety of a secondary battery (hereinafter also referred to as a “battery”) while maintaining good current collectability of the positive electrode. Furthermore, since the positive electrode comprising a protective layer containing a silicone resin has excellent flexibility, the stress applied to the positive electrode when the electrode is wound is relaxed, and thus the protective layer and the positive electrode mixture layer are hardly cracked, resulting in preventing a decrease in yield in the manufacturing process for batteries. In addition, the weight of the protective layer including a silicone resin is reduced compared to the protective layer containing inorganic compound particles as a main component, and thus the total weight of the battery can be reduced while maintaining the function of suppressing increase in temperature when abnormalities occur.

Hereinafter, one example of the embodiments of the present disclosure will be described in detail with reference to a drawing. The drawing referred to in the description of the embodiments is schematically illustrated, and the dimension ratio of components shown in the drawing may different from that of actual components. The specific dimension ratio should be estimated with reference to the following description.

### [Secondary Battery]

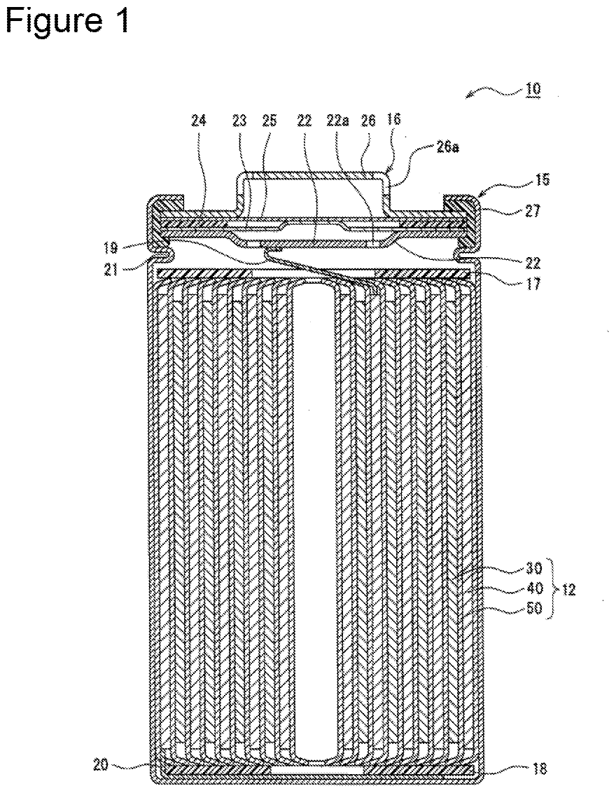

Using FIG. 1, the configuration of a battery 10 will be described. FIG. 1 is a sectional view of the battery 10 as one example of the embodiments. The battery 10 comprises a positive electrode 30, a negative electrode 40, and an electrolyte. It is preferable to provide a separator 50 between the positive electrode 30 and the negative electrode 40. The battery 10 has, for example, a structure in which a wound-type electrode assembly 12 formed by winding the positive electrode 30 and the negative electrode 40 together with the separator 50 therebetween, and the electrolyte are housed in a battery case. As a battery case for housing the electrode assembly 12 and the electrolyte, a metallic case in a shape, such as a cylindrical shape, a rectangular shape, a coin shape and a button shape, and a resin case formed by laminating resin sheets (laminate-type battery) can be exemplified. Instead of the wound-type electrode assembly 12, other forms of electrode assemblies may be applied, for example, a laminate-type electrode assembly and the like formed by alternately laminating positive electrodes and negative electrodes with separators interposed therebetween. In the example shown in FIG. 1, the battery case includes a bottomed cylindrical case body 15 and a sealing body 16.

The battery 10 comprises insulating plates 17, 18 disposed on the top and bottom of the electrode assembly 12, respectively. In the example shown in FIG. 1, a positive electrode lead 19 attached to the positive electrode 30 passes through a through-hole of the insulating plate 17 and extends toward the sealing body 16, and a negative electrode lead 20 attached to the negative electrode 40 passes through the exterior of the insulating plate 18 and extends toward the bottom of the case body 15. For example, the positive electrode lead 19 is connected by welding etc. to the lower surface of the filter 22 which is a bottom plate of the sealing body 16, and a cap 26 which is a top plate of the sealing body 16 connected electrically to the filter 22 serves as a positive electrode terminal. The negative electrode lead 20 is connected by welding etc. to an inner surface of a bottom of the case body 15, and thus the case body 15 serves as a negative electrode terminal. In the present embodiment, the sealing body 16 comprises a current breaking mechanism (CID) and a gas discharging mechanism (safety valve). In addition, it is preferable to provide a gas discharging valve (not shown) also at the bottom of the case body 15.

A case body 15 is, for example, a bottomed cylindrical container made of metal. A gasket 27 is provided between the case body 15 and the sealing body 16 to ensure sealability inside the battery case. The case body 15 preferably has a projection part 21 for supporting the sealing body 16, wherein the projection part 21 is for example formed by pressing a side wall from outside. The projection part 21 is preferably formed annularly along the circumferential direction of the case body 15, and the sealing body 16 is supported on upper surface of the projection part 21.

The sealing body 16 has a filter 22 in which a filter opening part 22a is formed and valve elements disposed on the filter 22. The valve elements cover the filter opening part 22a of the filter 22, and rupture when the internal pressure within the battery 10 increases due to heat generation caused by internal short-circuit etc. In the present embodiment, a lower valve element 23 and an upper valve element 25 are provided as valve elements.

An insulating component 24 disposed between the lower valve element 23 and the upper valve element 25, and a cap 26 having a cap opening part 26a are further provided. Each component constituting the sealing body 16 has for example a disk shape or a ring shape, and the each component except for the insulating component 24 is electrically connected to each other. Specifically, the filter 22 and the lower valve element 23 are bonded each other in the peripheral edge parts thereof. The upper valve element 25 and the cap 26 are also bonded each other in the peripheral edge parts thereof. The lower valve element 23 and the upper valve element 25 are connected each other in the center parts thereof, and the insulating component 24 is interposed between the peripheral edge parts of those valve elements. When the internal pressure increases due to heat generation caused by short-circuit etc., the lower valve element 23, for example, raptures in a thin part, and thus the upper valve element 25 swells toward the cap 26 and is spaced apart from the lower valve element 23 resulting in breaking of electrical connection of both valve elements.

### [Positive Electrode]

The positive electrode 30 comprises a positive electrode current collector, a protective layer formed on the positive electrode current collector, and a positive electrode mixture layer formed on the protective layer.

The positive electrode current collector includes aluminum and is composed of a metallic foil consisting of, for example, aluminum alone or an aluminum alloy. The content of aluminum in the positive electrode current collector is 50 mass % or more based on the total amount of the positive electrode current collector, preferably 70 mass % or more, more preferably 80 mass % or more. The thickness of the positive electrode current collector is not particularly limited, but for example about 10 μm or more and 100 μm or less.

The positive electrode mixture layer includes a positive electrode active material composed of a lithium transition metal oxide. As a lithium transition metal oxide, lithium transition metal oxides containing lithium (Li) and a transition metal such as cobalt (Co), manganese (Mn) and nickel (Ni) can be exemplified. The lithium transition metal oxide may include additive elements other than Co, Mn and Ni, and for example, aluminum (Al), zirconium (Zr), boron (B), magnesium (Mg), scandium (Sc), yttrium (Y), titanium (Ti), iron (Fe), copper (Cu), zinc (Zn), chromium (Cr), lead (Pb), tin (Sn), sodium (Na), potassium (K), barium (Ba), strontium (Sr), calcium (Ca), tungsten (W), molybdenum (Mo), niobium (Nb) and silicon (Si) can be exemplified.

Specific examples of the lithium transition metal oxide include, for example, LiₓCoO₂, LiₓNiO₂, LiₓMnO₂, LiₓCo_{y}Ni_{1-y}O₂, LiₓCo_{y}Mi_{1-y}O_{z}, LiₓNi_{1-y}M_{y}O_{z}, LiₓMn₂O₄. LiₓMn_{2-y}M_{y}O₄, LiMPO₄, Li₂MPO₄F (for each chemical formula, M is at least one of Na, Mg, Sc, Y, Mn, Fe, Co, Ni, Cu, Zn, Al, Cr, Pb, Sb and B, and 0≤x≤1.2, 0<y≤0.9, 2.0≤z≤2.3). These may be used singly or as a mixture of two or more.

The positive electrode mixture layer preferably further includes a conductive agent and a binding agent. The conductive agent included in the positive electrode mixture layer is used to enhance the electrical conductivity of the positive electrode mixture layer. Examples of the conductive agent include carbon materials such as carbon black (CB), acetylene black (AB), Ketchen black and graphite. These may be used singly or in combinations of two or more thereof.

The binding agent included in the positive electrode mixture layer is used for maintaining good contact condition between the positive electrode active material and the conductive agent and for enhancing binding property of the positive electrode active material etc. to the surface of the positive electrode current collector. Examples of the binding agent include fluorine-based resins such as polytetrafluoroethylene (PTFE) and polyvinylidene fluoride (PVdF), polyacrylonitrile (PAN), polyimide-based resins, acrylic resins, polyolefin-based resins. Furthermore, these resins can be used in combination with carboxymethylcellulose (CMC) or salts thereof (CMC-Na, CMC-K, CMC-NH₄ etc, or may be partially neutralized salts), polyethylene oxide (PEO) etc. These may be used singly or in combinations of two or more thereof.

The positive electrode 30 comprises a protective layer formed on the positive electrode current collector, and the positive electrode mixture layer is formed on the protective layer. The protective layer includes at least a silicone resin and a conductive agent. The silicone resin included in the protective layer has a main chain composed of Si—O bonds which have very high bond energy, and thus has excellent heat resistance. Since silica (SiO₂) is generated by thermal decomposition of a silicone resin, the protective layer according to the present embodiment serves as a separating layer for separating the positive electrode current collector and the positive electrode mixture layer even after thermal decomposition of the silicone resin due to internal short-circuit etc. When such the protective layer is provided between the positive electrode current collector and the positive electrode mixture layer, it is possible to separate the positive electrode current collector and the positive electrode mixture layer even when abnormalities occur such as internal short-circuit, suppress an oxidation-reduction reaction between aluminum included in the positive electrode current collector and lithium transition metal oxide included in the positive electrode mixture layer as a positive electrode active material, and suppress increase in temperature of the battery 10.

The silicone resin included in the protective layer is represented by, for example, the following composition formula (1):

RₓSiO_{(4-x)/2} (1)

(wherein, each R independently represents a monovalent hydrocarbon group, the monovalent hydrocarbon group represented by R may be substituted with a halogen atom, and x satisfies 0.1≤x≤2), and is an organopolysiloxane having a three-dimensional network structure. x in composition formula (1) represents a substitution degree of a monovalent hydrocarbon group represented by R per silicon atom, i.e., per structural unit constituting an organopolysiloxane. x preferably satisfies 0.8≤x≤1.9, more preferably 1.2≤x≤1.8.

As structural units constituting the organopolysiloxane represented by the above composition formula (1), an M unit shown as R₃SiO_{1/2}, a D unit shown as R₂SiO_{2/2}, a T unit shown as RSiO_{3/2}, and a Q unit shown as SiO_{4/2} can be exemplified. x in composition formula (1) can be obtained from the existence ratio of these structural units constituting the organopolysiloxane. When the silicone resin has a T unit and/or a Q unit as a structural unit, the silicone resin forms a three-dimensional network structure having a branched structure.

A monovalent hydrocarbon group (hereinafter also referred to as “hydrocarbon group R”) represented by R which may be substituted with a halogen atom has, for example, 1 or more and 10 or less carbon atoms, preferably 1 or more and 6 or less carbon atoms. A halogen atom which may substitute the hydrocarbon group R is, for example, a fluorine atom, a chlorine atom etc. Specific examples of a hydrocarbon group R include, but are not limited to, alkyl groups such as a methyl group, an ethyl group, a propyl group, a butyl group, a pentyl group, a hexyl group, a heptyl group and an octyl group; cycloalkyl groups such as a cyclopentyl group and a cyclohexyl group; aryl groups such as a phenyl group, a tolyl group; aralkyl groups such as a 2-phenylethyl group, a 2-phenylpropyl group and a 3-phenylpropyl group; alkenyl groups such as a vinyl group and an allyl group; halogen-substituted hydrocarbon groups such as a chloromethyl group, a γ-chloropropyl group and a 3,3,3-trifluoropropyl group. As a hydrocarbon group R, an alkyl group having 1 to 4 carbon atoms and a phenyl group are preferable, and a methyl group and a phenyl group are particularly preferable, since compounds having such a group R are readily synthesized or readily available.

In terms of enhancement of heat resistance, the silicone resin preferably has at least a structural unit including a silicon atom having a phenyl group as a substituent. For example, the silicone resin is an organopolysiloxane represented by above composition formula (1), the ratio of phenyl groups bonded to silicon atoms based on the total amount of monovalent hydrocarbon groups R bonded to silicon atoms is preferably 10 mol % or more and 80 mol % or less, more preferably 20 mol % or more and 60 mol % or less. In the silicone resin, when the ratio of phenyl groups based on the total amount of hydrocarbon groups R bonded to silicon atoms is within the above range, heat resistance of the protective layer is even more enhanced.

The silicone resin preferably contains a hydroxyl group bonded to a silicon atom (silanol group) in a molecule. As described below, when a coating film including the silicone resin and the conductive agent is heated to form a protective layer, a silanol group included in the silicone resin undergoes dehydration condensation with another silanol group or a hydroxyl group on the surface of the current collector etc. Also a hydrolyzable functional group bonded to a silicon atom in the silicone resin has a similar function to that of a silanol group. Such a hydrolysable functional group is not limited as long as it is a substituent which undergoes dehydration condensation with a silanol group etc. by heating, and for example, alkoxy groups such as a methoxy group and an ethoxy group, an acetoxy group, an amino group can be exemplified. The content of the hydroxyl groups and hydrolyzable functional groups bonded to silicon atoms in the silicone resin is, for example, preferably 3 mass % or less based on the total amount of the silicone resin, more preferably 0.1 mass % or more and 2 mass % or less. The ratio of the structural units containing silanol groups or hydrolyzable functional groups based on the total structural units constituting the silicone resin is preferably about 20 mol % or less, more preferably 1 mol % or more and 10 mol % or less.

The weight average molecular weight of the silicone resin in terms of polystyrene obtained by the gel permeation chromatography (GPC) is preferably within the range of 1,000 to 5,000,000, more preferably within the range of 4,000 to 3,000,000.

Such the silicone resin can be manufactured by a conventional known method. For example, depending on the ratio of the structural units included in the structure of the target silicone resin, a corresponding organochlorosilane is co-hydrolyzed optionally in the presence of an alcohol having 1 to 4 carbon atoms, hydrochloric acid and low boiling point components generated as by-products are removed, and thus the target substance can be obtained. Also, alkoxysilanes, silicone oil and cyclic siloxane can be used as a starting material. In this case, an acid catalyst such as hydrochloric acid, sulfinic acid and methanesulfonic acid is used and optionally water is added for hydrolysis so that polymerization reaction proceeds, then the target silicone resin can be obtained by similarly removing the used acid catalyst and low boiling point components.

Specific examples of the starting material for synthesizing a silicone resin include, but not limited to, chlorosilanes such as methyltrichlorosilane, ethyltrichlorosilane, phenyltrichlorosilane, dimethyldichlorosilane and diphenyltrichlorosilane, alkoxysilanes such as methoxysilanes corresponding to respective chlorosilanes. Furthermore, the silicone resin can be used alone, or in combination of two or more having a different ratio of hydrocarbon groups as a substituent on silicon atoms and silanol groups.

As a silicone resin included in the protective layer, an organic resin-modified silicone resin can be also used, and for example, an epoxy resin-modified silicone resin, alkid resin-modified silicone resin or polyester resin-modified silicone resin etc. can be used. However, the silicone resin included in the protective layer is preferably a so-called straight silicone resin substantially composed of an organopolysiloxane represented by the above composition formula (1) in terms of heat stability. The silicone resin is preferably an organopolysiloxane, for example represented by the above composition formula (1), wherein a monovalent hydrocarbon group represented by R is selected from the group consisting of a methyl group, an ethyl group, a propyl group, a butyl group, a pentyl group, a hexyl group, a heptyl group, an octyl group, a cyclopentyl group, a cyclohexyl group, a phenyl group, a tolyl group, a 2-phenylethyl group, a 2-phenylpropyl group, a 3-phenylpropyl group, a vinyl group, an allyl group, a chloromethyl group, a γ-chloropropyl group, and a 3,3,3-trifluoropropyl group, more preferably selected from the group consisting of a methyl group and a phenyl group. x satisfies 1.2≤x≤1.8, the content of hydroxyl groups and hydrolysable fimctional groups bonded to silicon atoms is 3 mass % or less based on the total amount of the silicone resin, more preferably 0.1 mass % or more and 2 mass % or less, and the weight average molecular weight in terms of polystyrene obtained by GPC is preferably within the range of 4,000 to 3,000,000.

The content of the silicone resin included in the protective layer may be, for example, 10 mass % or more and 99.9 mass % or less based on the total amount of the protective layer, and is preferably 15 mass % or more and 99 mass % or less. When the protective layer does not include inorganic compound particles (hereinafter also referred to as “inorganic particles”) described below, the content of the silicone resin is preferably, for example, 60 mass % or more and 99 mass % or less based on the total amount of the protective layer, more preferably 75 mass % or more and 95 mass % or less. When the protective layer includes inorganic particles, the content of the silicone resin is preferably, for example, 10 mass % or more and 60 mass % or less based on the total amount of the protective layer, more preferably 15 mass % or more and 55 mass % or less.

The content of the silicone resin based on the total amount of the positive electrode may be, for example, 0.01 mass % or more and 3.0 mass % or less, preferably 0.02 mass % or more and 2.0 mass % or less. When the protective layer does not include inorganic particles, the content of the silicone resin based on the total amount of the positive electrode is preferably, for example, 0.05 mass % or more and 2.0 mass % or less, more preferably 0.09 mass % or more and 1.52 mass % or less. When the protective layer includes inorganic particles, the content of the silicone resin based on the total amount of the positive electrode is preferably, for example, 0.02 mass % or more and 1.5 mass % or less, more preferably 0.04 mass % or more and 1.21 mass % or less.

The protective layer contains a conductive agent together with the silicone resin. When the protective layer provided between the positive electrode current collector and the positive electrode mixture layer contains a conductive agent, good current collectability of the positive electrode 30 is secured. The conductive agent may be, for example, the same type of conductive agent as the one used in the positive electrode mixture layer. Specific examples of such a conductive agent include, but not limited to, carbon materials such as carbon black (CB), acetylene black (AB), Ketchen black, and graphite. These may be used singly or in combinations of two or more thereof.

Furthermore, the present inventors found that when the above carbon material is used as a conductive agent in the positive electrode 30 according to the present embodiment, suppression effect on increase of temperature when abnormalities occur is much more enhanced compared to the case in which a conductive agent is not contained. The reason why suppression effect on increase of temperature is enhanced when a conductive agent consisting of a silicone resin and a carbon material are contained is not clear, but is supposed to be as follows. For example, there is a possibility that a radical on the surface of the carbon material captures an active species generated by thermal decomposition of a binder or an electrolyte etc. during abnormal heat generation and thus increase in temperature is suppressed. Also, there is a possibility that a compound having a Si—C bond is generated from a thermal decomposition product of the silicone resin generated by increase in temperature and a carbon material, and the compound forms an oxygen barrier layer, and thus oxidation reaction of aluminum of the positive electrode current collector is suppressed. The conductive agent is preferably the above carbon material, more preferably an amorphous material containing radical species such as acetylene black, Ketchen black in large amount.

The content of the conductive agent included in the protective layer may be, for example, 1 mass % or more and 40 mass % or less based on the total amount of the protective layer, more preferably 2 mass % more and 25 mass % or less. When the protective layer does not include inorganic particles, the content of the conductive agent is preferably, for example, 1 mass % or more and 40 mass % or less based on the total amount of the protective layer, more preferably 5 mass % or more and 25 mass % or less. When the protective layer includes inorganic particles, the content of the conductive agent is preferably, for example, 1 mass % or more and 30 mass % or less based on the total amount of the protective layer, more preferably 2 mass % or more and 20 mass % or less. In terms of securing of current collectability, the content of the conductive agent in the protective layer is preferably higher than the content of the conductive agent in the positive electrode mixture layer.

The content of the conductive agent based on the total amount of the positive electrode may be, for example, 1 mass % or more and 40 mass % or less, more preferably 2 mass % or more and 25 mass % or less. When the protective layer does not include inorganic particles, the content of the conductive agent based on the total amount of the positive electrode is preferably, for example, 0.01 mass % or more and 0.6 mass % or less, more preferably 0.01 mass % or more and 0.31 mass % or less. When the protective layer includes inorganic particles, the content of the conductive agent based on the positive electrode is preferably, for example, 0.01 mass % or more and 0.5 mass % or less, more preferably 0.01 mass % or more and 0.28 mass % or less.

The protective layer may contain inorganic particles. As a positive electrode for a non-aqueous electrolyte secondary battery comprising a protective layer including inorganic particles, Japanese Unexamined Patent Application Publication No. 2016-127000 discloses the positive electrode for a non-aqueous electrolyte secondary battery comprising a protective layer having a thickness of 1 μm to 5 μm and including an inorganic compound having the oxidizing power lower than that of a lithium transition metal oxide, and a conductive agent, wherein the protective layer is disposed between the positive electrode current collector containing aluminum as a main component and the positive electrode mixture layer including a lithium transition metal oxide. Similarly to the silicone resin, the inorganic particles included in the protective layer has an effect of suppressing increase in temperature when abnormalities of the battery 10 occur, but the protective layer containing inorganic particles as a main component has high stiffness. Unlike the case of the positive electrode comprising the protective layer containing inorganic particles as a main component as disclosed in Japanese Unexamined Patent Application Publication No. 2016-127000, in the positive electrode 30 according to the present embodiment in which the silicone resin is contained instead of a part or all of the inorganic particles, the stress applied to the positive electrode 30 when the electrode assembly 12 is wound is relaxed, and thus the protective layer and the positive electrode mixture layer formed on the current collector are hardly cracked, resulting in preventing a decrease in yield in the manufacturing process for batteries 10. In addition, since a silicone resin has lower density and light-weight compared inorganic particles, when the silicone resin is used instead of a part or all of inorganic particles, the weight of the protective layer and thus the total weight of the battery 10 can be reduced while maintaining the function of suppressing increase in temperature when abnormalities occur. Furthermore, in the protective layer containing inorganic particles as a main component, use of a binding agent is desired for securing mechanical strength and bondability with the current collector or mixture layer, and so on, while in the case of positive electrode 30 according to the present embodiment, it is possible to secure mechanical strength of the protective layer and bondability with the current collector or mixture layer due to the silicone resin, even if a binding agent is not used.

The inorganic compound constituting the inorganic particles is not particularly limited, but preferably has a lower oxidizing power than the lithium transition metal oxide included in the positive electrode mixture layer in terms of suppressing of an oxidation-reduction reaction. As such an inorganic compound, for example, inorganic oxides such as manganese oxide, silicon dioxide, titanium dioxide and aluminum oxide can be exemplified, and aluminum oxide (Al₂O₃) is preferable since it has excellent thermal conductivity. The inorganic particles may have, for example, a central particle size (volume average particle size measured by the light scattering method) of 1 μm or less, preferably 0.2 μm or more and 0.9 μm or less.

The content of the inorganic particles included in the protective layer may be, for example, 20 mass % or more and 85 mass % or less based on the total amount of the protective layer, preferably 40 mass % or more and 75 mass % or less, more preferably 55 mass % or more and 70 mass % or less. The content of the inorganic particles based on the total amount of the positive electrode may be, for example, 0.01 mass % or more and 8 mass % or less, preferably 0.03 mass % or more and 5 mass % or less, more preferably 0.06 mass % or more and 2.7 mass % or less.

In the present embodiment, a binding agent may be used in the protective layer in order to secure mechanical strength of the protective layer, or enhance bondability of the protective layer and the positive electrode current collector or bondability of the protective layer and the positive electrode mixture layer, but a binding agent may not be contained. When a binding agent is used, for example the same type of binding agent as the one used in the positive electrode mixture layer can be used. Specific examples of such a binding agent include, but not limited to, a fluorine-based resins such as PTFE and PVdF, PAN, polyimide-based resins, acrylic resins, and polyolefin-based resins. These may be used singly or in combinations of two or more thereof. When a binding agent is used, the protective layer may contain the binding agent in an amount of 0.1 mass % or more and 20 mass % or less based on the total amount of the protective layer, but preferably no binding agent is contained.

When the protective layer does not contain inorganic particles and is substantially composed only of the silicone resin and the conductive agent, the content ratio of the silicone resin to the conductive agent (mass ratio) is preferably 60:40 to 99:1, more preferably 75:25 to 95:5. Herein, “substantially composed only of” means that the content of components other than the constituents is as little as a trace amount, for example 0.1 mass % or less.

When the protective layer is substantially composed only of a silicone resin, conductive agent and inorganic particles, the content ratio (mass ratio) of the total amount of the silicone resin and conductive agent to the inorganic particles is preferably 60:40 to 25:75, more preferably 45:55 to 30:70. Furthermore, when the protective layer is substantially composed only of a silicone resin, conductive agent and inorganic particles, the content ratio (mass ratio) of the total amount of the silicone resin and inorganic particles to the conductive agent is preferably 99:1 to 70:30, more preferably 98:2 to 80:20. Otherwise, when the protective layer is substantially composed only of a silicone resin, conductive agent and inorganic particles, preferably the content of the silicone resin is 15 mass % or more and 55 mass % or less, the content of the inorganic particles is preferably 40 mass % or more and 75 mass % or less, the content of the conductive agent is 2 mass % or more and 20 mass % or less based on the total amount of the protective layer, and the silicone resin, conductive agent and inorganic particles are included so that the total amount thereof is 100 mass %.

The thickness of the protective layer is, for example, 1 μm or more and 10 μm or less, preferably 1 μm or more and 5 μm or less. When the protective layer is too thin, the effect of suppressing increase in temperature when abnormalities occur can be reduced, and when the protective layer is too thick, the energy density of the positive electrode 30 can be reduced.

The analysis method of components included in the protective layer includes, for example, the following method.

(1) The battery 10 is disassembled and the electrode assembly 12 is removed to be further separated into the positive electrode 30, the negative electrode 40 and the separator 50.

(2) The specified area of the positive electrode 30 obtained in (1) is cut out to obtain a sample comprising the positive electrode current collector, the protective layer and the positive electrode mixture layer.

(3) The binding agent is dissolved using the organic solvent that dissolves the binding agent included in the positive electrode mixture layer and does not dissolve the silicone resin to remove the positive electrode mixture layer from the positive electrode 30.

(4) The protective layer is scraped off from the sample obtained from (3) using a cutting tool etc.

(5) The constituents of the protective layer obtained in (4), including the silicone resin and the conductive agent etc., are qualitatively and quantitatively analyzed using known analytical apparatus such as a nuclear magnetic resonance (NMR) apparatus and Fourier transform infrared spectrophotometer (FT-IR). The silicone resin is subjected to pre-treatment, for example, in which siloxane bonds of the silicone resin are cleaved using tetraethoxysilane (TEOS) under an alkaline condition, then the structure of monomer units constituting the silicone resin can be analyzed by measuring the obtained ethoxylated compound using a gas chromatograph mass spectrometer (GC-MS). The molecular weight of the silicone resin can be measured as weight average molecular weight in terms of polystyrene, for example, using a gel permeation chromatograph (GPC) apparatus.

The organic solvent used in above (3) is known, and for example, when a fluorine-based resin such as PVdF is used as the binding agent included in the positive electrode mixture layer, only the positive electrode mixture layer can be removed from the positive electrode 30 by using acetonitrile as an organic solvent. Also, instead of the step of the above (3), the thickness of the positive electrode mixture layer and the protective layer is measured in advance, and only the positive electrode mixture layer may be scraped off using a cutting tool etc. based on the measured thickness. The positive electrode 30 obtained in above (1) is, for example, subjected to cross-section processing by the cross-section polisher (CP) method, the polished surface is observed by a scanning electron microscope (SEM), and thus the thickness of the positive electrode mixture layer and the protective layer can be measured by conducting image processing of the obtained SEM image.

One example of the manufacturing method of the positive electrode 30 according to the present embodiment will be described. Firstly, the silicone resin is added to an organic solvent in which the silicone resin is soluble to prepare a solution, then additives such as a conductive agent and, if necessary, inorganic particles are added to the obtained solution to prepare a dispersion. The obtained dispersion is applied to the surface of the positive electrode current collector, and the applied layer is dried, and thus the protective layer can be formed on the positive electrode current collector. When positive electrode mixture layers are provided on the both sides of the positive electrode current collector, the protective layers are also provided on the both sides of the positive electrode current collector.

The organic solvent used for preparation of the dispersion is not particularly limited as long as the silicone resin is soluble or dispersible in the solvent, but includes for example, saturated aliphatic hydrocarbons such as n-pentane and hexane; alicyclic hydrocarbons such as cyclopentane and cyclohexane; aromatic hydrocarbons such as benzene, toluene, xylene and mesitylene; cyclic ethers such as tetrahydrofuran (THF) and dioxane; ketones such as methyl isobutyl ketone (MIBK); halogenated alkanes such as trichloroethane; halogenated aromatic hydrocarbons such as chlorobenzene, and may be a mixture of two or more of these.

Then, a positive electrode mixture slurry is prepared by mixing a positive electrode active material, a conductive agent and a binding agent, and a dispersion medium such as N-methyl-2-pyrrolidone (NMP). The obtained positive electrode mixture slurry is applied to the surface of the protective layer formed on the positive electrode current collector. After drying the applied layer, the positive electrode 30 according to the present embodiment can be manufactured by rolling the applied layer using a rolling means such as a rolling mill to form the positive electrode mixture layer on the protective layer. By rolling process using a rolling means, the positive electrode active material particles on the surface of the protective film side of the positive electrode mixture layer sink into the protective layer to form roughness at an interface between the protective layer and the positive electrode mixture layer. By an anchor effect of the positive electrode mixture layer and the protective layer generated by this formed roughness, bondability between the both can be secured. A method of applying the dispersion of the protective layer or the positive electrode mixture slurry is not particularly limited, and applying may be conducted using a known applying apparatus such as a gravure coater, slit coater and die coater.

### [Negative Electrode]

A negative electrode 40 is composed of a negative electrode current collector such as those made of a metallic foil for example and a negative electrode mixture layer formed on the surface of the negative electrode collector. For the negative electrode collector, metallic foils such as copper which are stable within the potential range of the negative electrode, and films and the like having such metals disposed on the surface can be used. The negative electrode mixture layer preferably includes a binding agent in addition to a negative electrode active material. The negative electrode 40 can be produced, for example, by applying a negative electrode mixture slurry including a negative electrode active material and a binding agent etc. to the negative electrode current collector, drying the applied layer, then rolling the applied layer to form a negative electrode mixture layer on both sides of the current collector.

The negative electrode active material is not particularly limited as long as it is a material capable of reversibly occluding and releasing a lithium ion, and for example, carbon materials such as natural graphite and artificial graphite, metals capable of forming alloys with lithium such as silicon (Si) and Tin (Sn), or alloys or complex oxides including metal elements such as Si and Sn can be used. These may be used singly or in combinations of two or more thereof.

As a binding agent included in the negative electrode mixture layer, fluorine-based resins, PAN, polyimide-based resins, acrylic resins, polyolefin-based resins etc. can be used, similarly to the case of the positive electrode 30. In the case of preparing a negative electrode mixture slurry using an aqueous solvent, it is preferable to use styrene-butadiene rubber (SBR), CMC or salts thereof polyacrylic acid (PAA) or salts thereof (PAA-Na, PAA-K etc., or may be partially neutralized salts), polyvinyl alcohol (PVA) etc.

### [Separator]

For a separator 50, for example, a porous sheet having ion permeability and insulating property is used. Specific examples of a porous sheet include fine porous thin film, woven fabric, non-woven fabric etc. As a material of the separator 50, olefin-based resins such as polyethylene and polypropylene, and cellulose etc. are suitable. The separator 50 may be a laminated product having a cellulose fiber layer and a thermoplastic resin fiber layer such as those made of an olefin-based resin etc. The separator may be a multilayer separator including a polyethylene layer and a polypropylene layer, or a separator having an aramid-based resin etc. applied on the surface of the separator 50 can be used.

A filler layer including an inorganic filler may be formed at an interface between the separator 50 and at least one of the positive electrode 30 and the negative electrode 40. As an inorganic filler, for example, oxides containing at least one of titanium (Ti), aluminum (Al), silicon (Si) and magnesium (Mg), and phosphate compounds can be exemplified. The filler layer can be formed by applying a slurry containing, for example such a filler on the surface of the positive electrode 30, the negative electrode 40 or the separator 50.

### [Electrolyte]

An electrolyte includes a solvent and an electrolyte salt dissolved in the solvent. A solid electrolyte using a gel polymer etc. can be used as an electrolyte, however, an electrolyte is preferably a liquid electrolyte in terms of fillability thereof into cavities of the protective layer and suppression of increase in temperature when abnormalities occur. As a solvent, for example, non-aqueous solvent such as esters, ethers, nitriles such as acetonitrile, amides such as dimethylformamide, and a mixed solvent of two or more of such solvents, and water can be used. A non-aqueous solvent may contain a halogen-substituted compound in which at least a part of hydrogen atoms of these solvents has been substituted with halogen atoms such as fluorine.

Examples of the above esters include cyclic carbonate esters such as ethylene carbonate (EC), propylene carbonate (PC) and butylene carbonate, chain carbonate esters such as dimethyl carbonate (DMC), methylethyl carbonate (EMC), diethyl carbonate (DEC), methylpropyl carbonate, ethylpropyl carbonate and methyl isopropyl carbonate, cyclic carboxylate esters such as γ-butyrolactone and γ-valerolactone, chain carboxylate esters such as methyl acetate, ethyl acetate, propyl acetate, methyl propionate (MP), ethyl propionate and γ-butyrolactone.

Examples of the above ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol and crown ethers, chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether and tetraethylene glycol dimethyl.

As an above halogen-substituted compound, cyclic fluorinated carbonate esters such as fluoroethylene carbonate (FEC), fluorinated chain carboxylate esters such as fluorinated chain carbonate ester and methyl fluoropropionate (FMP) are preferably used.

An electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂. Li(P(C₂O₄)F₄), LiPF₆₋ₓ(CₙF₂₊₁). (where 1<x<6, and n is 1 or 2), LiB₁₀Cl₁₀, LiCl, LiBr, LiI, chloroborane lithium, lithium short-chain aliphatic carboxylates, borate salts such as Li₂B₄O₇ and Li(B(C₂O₄)F₂), imide salts such as LiN(SO₂CF₃)₂ and LiN(C₁Fn₂ₗ₊₁SO₂)(CₘF₂ₘ₊₁SO₂) {where l and m are integers of 1 or more}. These lithium salts may be used singly or as a mixture of two or more thereof. Among these, it is preferable to use LiPF₆ in terms of ion conductivity and electrochemical stability. The concentration of the lithium salt is preferably 0.8 to 1.8 mol per 1 L of a solvent.

### EXAMPLES

Hereinafter, the present disclosure will be further described in more details by way of Examples, but is not limited to the following Examples.

### Example 1

### [Production of Positive Electrode]

Dow Corning (registered trademark) RSN-0805 (manufactured by Dow Corning Toray Co., Ltd.) including silicone resin contained in xylene in 50 mass % was used as a silicone resin-containing solution. In the silicone resin used, a hydrocarbon group R bonded to a silicon atom was either a phenyl group or a methyl group, the substitution degree x of a hydrocarbon group R per silicon atom was 1.6, and the ratio of phenyl groups and methyl groups bonded to silicon atoms based on the total amount of hydrocarbon groups R bonded to silicon atoms was 52.4 mol % and 47.6 mol % respectively. The content of hydroxyl groups bonded to silicon atoms (silanol group) in the silicone resin used was 1 mass % based on the total amount of the silicone resin, and was 6.9 mol % based on the total structural units constituting the silicone resin. The molecular weight of that silicone resin was about 2,000,000 to 3,000,000.

To this silicone resin-containing solution, acetylene black (AB) as a conductive agent was added and mixed so that the mass ratio of the silicone resin and the conductive agent was 95:5 to prepare a dispersion. Then, the resulting dispersion was applied to both sides of the positive electrode current collector consisting of an aluminum foil having a thickness of 15 μm, the applied layers were dried at 200° C. for 1 hour to evaporate a solvent and conduct dehydration condensation of the silicone resin, and thus protective layers having a thickness of 5 μm were formed on both sides of the positive electrode current collector.

97 parts by mass of lithium transition metal oxide represented by LiNi_{0.82}Co_{0.15}Al_{0.03}O₂, as a positive electrode active material, 2 parts by mass of acetylene black(AB), and 1 part by mass of polyvinylidene fluoride (PVdF) were mixed, and a suitable amount of N-methyl-2-pyrrolidone (NMP) was further added to the resulting mixture to prepare a positive electrode mixture slurry. Then, the resulting positive electrode mixture sluny was applied to both sides of a positive electrode current collector on which protective layers had been formed, and the applied slurry was dried. The resulting product was cut into the specified size of an electrode, rolled using a roller, and thus positive electrode 30 was produced which had the protective layers and the positive electrode mixture layers sequentially formed on both sides of positive electrode current collector.

### [Production of Negative Electrode]

98.7 parts by mass of graphite powder, 0.7 part by mass of carboxymethyl cellulose (CMC), and 0.6 part by mass of styrene-butadiene rubber (SBR) were mixed, and suitable amount of water was further added to the mixture to prepare a negative electrode mixture slurry. Then, the resulting negative electrode mixture slurry was applied to both sides of a negative electrode current collector consisting of copper foil, and dried. The resulting product was cut into the specified size of an electrode, rolled using a roller, and thus negative electrode 40 which had the negative electrode mixture layers formed on both sides of negative electrode current collector was produced.

### [Preparation of Electrolyte]

Ethylene carbonate (EC), methylethyl carbonate (EMC), and dimethyl carbonate (DMC) were mixed in a volume ratio of 3:3:4. LiPF₆ was dissolved in the resulting mixed solvent so as to obtain concentration of 1 mol/L to prepare a non-aqueous electrolyte.

### [Production of Battery]

The positive electrode 30 produced and the negative electrode 40 produced were wound together with a separator 50 therebetween, and a wound type electrode assembly 12 was thereby produced. A fine porous film of polyethylene having a heat resistant layer formed on one side was used for the separator 50, wherein a filler of polyamide and alumina was dispersed in the heat resistant layer. The resulting electrode assembly 12 was housed in a bottomed cylindrical case body 15 having outer diameter of 18 mm and height of 65 mm, the non-aqueous electrolyte was injected thereinto, then the opening part of the case body 15 was sealed by a gasket 27 and a sealing body 16, and thus the cylindrical non-aqueous electrolyte secondary battery of 18650 type having a rated capacity of 3100 mAh was produced.

### Example 2

A battery 10 was produced similarly to Example 1 except that in manufacturing process of a positive electrode 30, the amount of the dispersion applied was changed so that the thickness of the protective layer of 1 μm was obtained.

### Example 3

A battery 10 was produced similarly to Example 1 except that in manufacturing process of a positive electrode 30, acetylene black(AB), and inorganic particles consisting of aluminum oxide (Al₂O₃) were mixed with a silicone resin-containing solution (RSN-0805) so that the mass ratio of the silicone resin, the conductive agent and the inorganic particles was 25:5:70 to prepare a dispersion, and except that applied amount of the dispersion was changed so that the thickness of the protective layer of 5 μm was obtained.

### Comparative Example 1

A non-aqueous electrolyte secondary battery was produced similarly to Example 1 except that in manufacturing process of a positive electrode, a silicone resin-containing solution (RSN-0805) was used alone as a dispersion and applied amount of the dispersion was changed so that the thickness of the protective layer of 5 μm was obtained.

### Comparative Example 2

A non-aqueous electrolyte secondary battery was produced similarly to Example 1 except that in manufacturing process of a positive electrode, inorganic particles consisting of aluminum oxide (Al₂O₃), acetylene black(AB) and polyvinylidene fluoride (PVdF) were mixed in mass ratio of 93.5:5:1.5, and a suitable amount of N-methyl-2-pyrrolidone (NMP) as a dispersion medium was added to the resulting mixture to prepare a slurry, which was then applied to both sides of the positive electrode current collector and dried, and a protective layer having a thickness of 5 μm was thereby formed.

### [Nail Penetration Test]

For each non-aqueous electrolyte secondary battery, nail penetration tests were conducted according to the following procedures.
(1) The battery was charged at a constant current of 600 mA until the battery voltage reached 4.2 V under an environment of 25° C., then charging was continued until the current value reached 90 mA at a constant voltage.
(2) Under an environment of 25° C., the tip of a wire nail having a diameter of 2.7 mm ϕ was brought into contact with the center part of the side surface of the battery 10 charged in (1), and the battery was penetrated with the wire nail in the direction of lamination of the electrode assembly 12 in the battery 10 at a speed of 1 mm/s. Immediately after voltage drop of the battery due to internal short-circuit was detected, penetration of the wire nail was stopped.

(3) The temperature of the battery surface was measured 1 minute after short-circuit started to occur in the battery due to the wire nail.

### [Measurement of Internal Resistance]

The internal resistance was measured for each non-aqueous electrolyte secondary battery by the following procedures. Each battery was charged at a constant current of 0.3 It (600 mA) until the battery voltage reached 4.2 V under an environment of 25° C. After the battery voltage reached 4.2 V, charging was conducted at a constant voltage of 4.2 V. Then, resistance between terminals of each battery was measured using a specific resistance meter (AC four-terminal method in which frequency for measurement was set at 1 kHz), and the obtained resistance value was used as the internal resistance of each battery.

### [Stiffness Test]

A stiffness test was conducted for each positive electrode for a non-aqueous electrolyte secondary battery by the following procedures. A stiffness test is a test in which an outer peripheral surface of a positive electrode rounded cylindrically is pressed at a specified speed. Specific test procedures are as follows.

(1) A part in which a positive electrode is formed is cut into 8 cm×1 cm to produce a test electrode plate piece, and both ends of the piece are abutted to form a cylindrical body having a diameter of 2.55 cm.

(2) The cylindrical body of the above test electrode plate piece is disposed between an upper plate moving upward and downward and a lower plate having a fixing tool, and the abutted part of the cylindrical body is fixed using the fixing tool of the lower plate.

(3) The upper plate was moved downward at a speed of 100 mm/min to press the outer peripheral surface of the above cylindrical body. A stress generated in the above cylindrical body is measured at that time, and an inflection point in which the stress decreases rapidly is obtained. The stress at the point in which the inflection point is observed is measured as stiffness (unit: N).

The results of nail penetration tests and measurements of internal resistance conducted for the non-aqueous electrolyte secondary batteries of each Example and each Comparative Example, and the results of stiffness test conducted for positive electrodes for non-aqueous electrolyte secondary batteries of each Example and each Comparative Example were shown in Table 1 respectively.

TABLE 1

| | | | | | | | Nail penetration | Physical properties of | |
|---|---|---|---|---|---|---|---|---|---|
| | | | | | Thickness of | Battery | test | electrode plate | |
| | Content in protective | | | | protective layer | property | Temperature of | | Area density of |
| | layer [mass %] | | | | of | Internal | battery surface | | protective layer |
| | Silicone | Conductive | Inorganic | | one side | resistance | 1 minute after | Stiffness | of both sides |
| | resin | agent | particles | Binder | [μm] | [mΩ] | short-circuit | [N] | [mg/cm²] |
| Example 1 | 95 | 5 | 0 | 0 | 5 | 31 | 53 | 0.8 | 0.93 |
| Example 2 | 95 | 5 | 0 | 0 | 1 | 30 | 54 | 0.9 | 0.19 |
| Example 3 | 25 | 5 | 70 | 0 | 5 | 32 | 51 | 0.5 | 1.79 |
| Comparative | 100 | 0 | 0 | 0 | 5 | 98 | 60 | 0.8 | 1.01 |
| Example 1 | | | | | | | | | |
| Comparative | 0 | 5 | 93.5 | 1.5 | 5 | 32 | 50 | 0.2 | 2.65 |
| Example 2 | | | | | | | | | |

As can be seen from the results shown in Table 1, according to a battery 10 of each Example in which protective layer containing a silicone resin and a conductive agent is provided between a positive electrode current collector and a positive electrode mixture layer, internal resistance of the battery 10 is significantly improved, and good current collectability can be ensured. It is considered that these results are due to the fact that the protective layer contains a conductive agent. According to the results of comparison of each Example and Comparative Example 1 shown in Table 1, compared to the battery of Comparative Example 1 using a protective layer composed only of a silicone resin and containing no conductive agent, the battery 10 of each Example using a protective layer containing a combination of a silicone resin and a conductive agent can much more suppress increase in temperature when abnormalities occur such as nail penetration. The reason of these results is not clear, but for example, there is a possibility that a radical on the surface of the conductive agent captured an active species generated during abnormal heat generation, and thus increase in temperature was suppressed, and there is a possibility that a silicone resin thermally decomposed during abnormal heat generation and a carbon material formed a new oxygen barrier layer.

As can be seen from the results shown in Table 1, according to the battery 10 of each Example, flexibility of a positive electrode can be significantly enhanced, and in addition, the weight of a protective layer can be significantly reduced. It is considered that these results are due to the fact that a silicone resin having excellent flexibility and low density was used for the protective layer. These results are apparent from the results of comparison between the battery 10 of Examples 1 and 2 in which the protective layer contains a silicone resin and a conductive agent and does not contain inorganic particle, and the battery 10 of Example 3 in which the protective layer contains a silicone resin, a conductive agent and inorganic particles.

### REFERENCE SIGNS LIST

10 Secondary battery (battery)
12 Electrode assembly
15 Case body
16 Sealing body
17,18 Insulating plate
19 Positive electrode lead
20 Negative electrode lead
21 Projection part
22 Filter
22a Filter opening part
23 Lower valve element
24 Insulating component
25 Upper valve element
26 Cap
26a Cap opening part
27 Gasket
30 Positive electrode
40 Negative electrode
50 Separator

1. A positive electrode for a secondary battery, comprising:
a positive electrode current collector;
a protective layer formed on the positive electrode current collector and including a silicone resin and a conductive agent; and
a positive electrode mixture layer formed on the protective layer and including a positive electrode active material composed of a lithium-containing transition metal oxide,
wherein the silicone resin is an organopolysiloxane represented by a following composition formula (1):
RₓSiO_{(4-x)/2} (1)
wherein, each R independently represents a monovalent hydrocarbon group, hydrogen of the monovalent hydrocarbon group represented by R may be substituted with a halogen atom, and x satisfies 0.1≤x≤2.

2. The positive electrode for a secondary battery according to claim 1, wherein R in the composition formula (1) represents a substituent selected from the group consisting of a methyl group, an ethyl group, a propyl group, a butyl group, a pentyl group, a hexyl group, a heptyl group, an octyl group, a cyclopentyl group, a cyclohexyl group, a phenyl group, a tolyl group, a 2-phenylethyl group, a 2-phenylpropyl group, a 3-phenylpropyl group, a vinyl group, an allyl group, a chloromethyl group, a γ-chloropropyl group and a 3,3,3-trifluoropropyl group.

3. The positive electrode for a secondary battery according to claim 1, wherein the organopolysiloxane represented by the composition formula (1) has at least a structural unit including a silicon atom having a phenyl group as a substituent.

4. The positive electrode for a secondary battery according to claim 3, wherein a ratio of phenyl groups bonded to silicon atoms based on a total amount of monovalent hydrocarbon groups R bonded to silicon atoms is 10 mol % or more and 80 mol % or less, in the organopolysiloxane represented by the composition formula (1).

5. The positive electrode for a secondary battery according to claim 1, wherein the silicone resin contains a hydroxyl group and a hydrolyzable functional group bonded to a silicon atom in a molecule, and wherein a content of the hydroxyl groups and the hydrolyzable functional groups is 3 mass % or less based on a total amount of the silicone resin.

6. The positive electrode for a secondary battery according to claim 1, wherein a thickness of the protective layer is 1 μm or more and 10 μm or less.

7. The positive electrode for a secondary battery according to claim 1, wherein the protective layer does not contain inorganic compound particles, a content of the silicone resin is 75 mass % or more and 95 mass % or less based on a total amount of the protective layer, and a content of the conductive agent is 5 mass % or more and 25 mass % or less based on a total amount of the protective layer.

8. The positive electrode for a secondary battery according to claim 1, wherein the protective layer further includes inorganic compound particles.

9. The positive electrode for a secondary battery according to claim 8, wherein based on a total amount of the protective layer, a content of the silicone resin is 15 mass % or more and 55 mass % or less, a content of the conductive agent is 2 mass % or more and 20 mass % or less, and a content of the inorganic compound particles is 40 mass % or more and 75 mass % or less.

10. A secondary battery, comprising:
the positive electrode for a secondary battery according to claim 1;
a negative electrode; and
an electrolyte.

11. A positive electrode for a secondary battery, comprising:
a positive electrode current collector;
a protective layer formed on the positive electrode current collector and including a silicone resin and a conductive agent; and
a positive electrode mixture layer formed on the protective layer and including a positive electrode active material composed of a lithium-containing transition metal oxide,
wherein a thickness of the protective layer is 1 μm or more and 10 μm or less.

12. The positive electrode for a secondary battery according to claim 11, wherein the silicone resin contains a hydroxyl group and a hydrolyzable functional group bonded to a silicon atom in a molecule, and wherein a content of the hydroxyl groups and the hydrolyzable functional groups is 3 mass % or less based on a total amount of the silicone resin.

13. The positive electrode for a secondary battery according to claim 11, wherein the protective layer does not include inorganic compound particles, a content of the silicone resin is 75 mass % or more and 95 mass % or less based on a total amount of the protective layer, and a content of the conductive agent is 5 mass % or more and 25 mass % or less based on a total amount of the protective layer.

14. The positive electrode for a secondary battery according to claim 11, wherein the protective layer further includes inorganic compound particles.

15. The positive electrode for a secondary battery according to claim 14, wherein based on a total amount of the protective layer, a content of the silicone resin is 15 mass % or more and 55 mass % or less, a content of the conductive agent is 2 mass % or more and 20 mass % or less, and a content of the inorganic compound particles is 40 mass % or more and 75 mass % or less.

16. A secondary battery, comprising:
The positive electrode for a secondary battery according to claim 11;
a negative electrode; and
an electrolyte.
